(19) United States
(12) Patent Application Publication
(10) Pub. No.: US 2004/0007870 A1
(43) Pub. Date: Jan. 15, 2004

(54) Trading card, card case, collector's item, and genuine/counterfeit determination apparatus

(75) Inventor: Takashi Ueno, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: R & B 21, Tokyo (JP)

(21) Appl. No.: 10/419,931

(22) Filed: Apr. 22, 2003

(30) Foreign Application Priority Data
Jun. 20, 2002 (JP) 2002-003764

(51) Int. Cl. G09F 1/00

(52) U.S. Cl. 283/72; 40/124.01

(57) ABSTRACT

In a trading card, a famous athlete's photograph is printed on a substrate of, for example, paper or plastic. The trading card has a signing portion and a seal portion. An IC chip is mounted in the trading card. An autograph is signed in the signing portion, and a seal is affixed in the seal portion. The signing portion and the seal portion are surface-treated; e.g., by means of increasing the surface friction, so that clear signing and seal affixing can be performed. The seal has a seal profile representing a character or a symbol relating to an athlete, preferably unique to him or her; e.g., the athlete's name, uniform number, or motto, etc.

### BACKGROUND OF THE INVENTION

1. Field of the Invention

The present invention relates to a collector's item, such as a trading card and a card case, on which item a photograph, name, etc. of, for example, a famous athlete is printed. Further, the present invention relates to an apparatus for determining whether an autograph and/or a seal which are provided on the collector's item is genuine or counterfeit.

2. Description of the Related Art

A trading card, which is one of various collector's items, is a card having a substrate of, for example, paper or plastic, on which a famous athlete's photograph, name, etc. is printed. Card collectors in Japan, the United States, as other countries have hitherto engaged in the flourishing exchange, sales, and purchase of trading cards. In particular, a rare card; e.g., a card on which appears an athlete's personal autograph or a card which is accompanied by a scrap of a uniform or the like that the athlete has worn, is traded at a high price. Further, a collector's item; e.g., a sporting article, such as a ball, on which a famous athlete's autograph, etc. appears, is treated as the valuable.

An essential requirement for fostering exchange, sales, etc. of collector's items, such as the above-described trading cards, is development of brand new products and collector's items; e.g., premium cards that have never existed previously. Further, as exchange and sale of these collector's items become progressively rousing, countermeasures against circulation of forgeries becomes necessary.

### SUMMARY OF THE INVENTION

In view of the foregoing, a first object of the present invention is to provide a new, improved trading card, as a new premium article, on which card an athlete has affixed his or her personal seal to enhance the value of the trading card and which card includes an IC chip storing at least information relating to the seal so as to enhance the credibility of the trading card.

A second object of the present invention is to provide a new, improved card case, as a new premium article, on which case an athlete has affixed his or her personal seal so as to enhance the value of the card case and which case includes an IC chip storing at least information relating to the seal so as to enhance the credibility of the card case.

A third object of the present invention is to provide a new, improved collector's item, as a new premium article, on which item an athlete affixed his or her personal seal so to enhance the value of the collector's item and which item includes an IC chip storing at least information relating to the seal so as to enhance the credibility of the collector's item.

A fourth object of the present invention is to provide a new, improved genuine/counterfeit determination apparatus which is capable of determining whether a seal appearing on a trading card, a card case, or a collector's item is genuine or counterfeit.

In order to achieve the above first object, according to a first aspect of the present invention, there is provided a trading card having a seal. Preferably, a front surface of the trading card, on which surface the seal is to be affixed, is surface-treated so as to facilitate affixing of the seal. Further, the trading card may further have an autograph, which is signed in, for example, a signing portion.

The seal is unique to a person whose photograph appears on the trading card; represents the name, the uniform number, or other related particulars; and is preferably affixed by the person himself or herself. By virtue of the trading card of the first aspect, the seal and the autograph can make the trading card precious so that exchange, sales, and purchase of trading cards between card collectors would flourish. Further, if a seal portion in which the seal is to be affixed is surface-treated, clear affixing of the seal can be effected. In this specification, the word seal is used for the equivalent for Rakkan in Japanese language.

Further, an IC chip may be mounted in the trading card so that information relating to the seal, the autograph, the owner, etc. can be stored in the IC chip. In addition, an image of the genuine seal and an image of the genuine autograph, or an image of the athlete affixing his or her own seal and/or signing his or her autograph may be stored in the IC chip in order to allow determination of whether the seal and/or the autograph is genuine or counterfeit.

If information regarding the presence/absence of a seal, the image of the affixed seal, the presence/absence of an autograph, the date/time of affixing the seal or signing, etc. is stored in the IC chip, the credibility of the trading card is enhanced so that card collectors can exchange, sell, or purchase the trading card safely. Further, since the IC chip is embedded in the trading card, the appearance of the trading card is not deteriorated.

In order to achieve the above second object, according to a second aspect of the present invention, there is provided a card case comprising: a card accommodation portion for accommodating a trading card; an IC chip accommodation portion for accommodating an IC chip; and a seal. Preferably, a front surface of the card case, on which surface the seal is to be affixed, is surface-treated so as to facilitate affixing of the seal. The card case may further have an autograph. In the IC chip, information relating to the seal, information relating to the autograph, etc. can be stored. An image of at least one of a genuine seal and a genuine autograph may be stored in the IC chip so that a determination can be made as to whether the seal and/or the autograph on the card case is genuine or counterfeit.

According to the card case of the second aspect, the trading card can be protected to thereby maintain the worth of the trading card so that possessing the card case for a long period of time can be expected to make the card case precious.

In order to achieve the above third object, according to a third aspect of the present invention, there is provided a collector's item having a seal. Preferably, a front surface of the collector's item on which the seal is to be affixed is surface-treated so as to facilitate affixing of the seal. If the seal representing the name, etc. of a famous athlete is affixed on the collector's item, the collector's item can be made precious. Further, an IC chip may be mounted in the collector's item. In the IC chip, information relating to the seal can be stored. The collector's item is, for example, a sporting article such as a ball, a famous athlete's photograph, etc. If information regarding the presence/absence of a seal, the image of the affixed seal, the presence/absence of an autograph, the date/time of affixing the seal or signing, etc. is stored in the IC chip, the credibility of the collector's item can be enhanced. An image of a genuine seal and/or a genuine autograph may be stored in the IC chip so that a determination can be made as to whether the seal and/or the autograph is genuine or counterfeit.

Further, the collector's item may be placed on a signing paperboard serving as a mat, and the collector's item, together with the mat, may be accommodated in the frame. In this case, the seal and the IC chip are preferably provided on the collector's item, the mat, or the frame. Because the collector's item is mounted in the frame, the collector's item can endure for a long period of time, and the framed article is also suitable when the framed article is displayed indoors, for example. Further, in the first to third aspects, the seal, the autograph, etc. may be provided on a label so that the seal, the autograph, etc. can be provided on the collector's item in a simple manner without having to bring the collector's item to a famous athlete.

In order to achieve the above fourth object, according to a fourth aspect of the present invention, there is provided a genuine/counterfeit determining apparatus comprising means for reading an image of one of a genuine seal and a genuine autograph which are stored in an IC chip; means for reading an image of one of a seal and an autograph which are provided on a collector's item; means for comparing the image of one of the genuine seal and the genuine autograph with the image of the corresponding one of the seal and the autograph which are provided on the collector's item; and means for determining, from the result of the comparison, whether one of the seal and the autograph which are provided on the collector's item is genuine or counterfeit. The apparatus of the fourth aspect determines whether at least one of the seal and the autograph on a collector's item such as a trading card or a sporting article is genuine or counterfeit. In the apparatus of the fourth aspect, an image of the genuine seal or an image of the genuine autograph is previously stored in the IC chip, and the stored image data is read. Meanwhile, an image of one of the seal and the autograph on the collector's item is read. Subsequently, the read image of one of the genuine seal and the genuine autograph is compared with the image of the corresponding one of the seal and the autograph on the collector's item to thereby determine whether one of the seal and the autograph on the collector's item is genuine or counterfeit.

### BRIEF DESCRIPTION OF THE DRAWINGS

Various other objects, features, and many of the attendant advantages of the present invention will be readily appreciated as the same becomes better understood by reference to the following detailed description of the preferred embodiments when considered in connection with the accompanying drawings, in which:

FIG. 1 is a plan view of a trading card according to a first embodiment of the present invention;

FIG. 2 is a table showing card information;

FIG. 3 is a perspective view of a card case;

FIG. 4 is a side view of the card case as viewed from point P in FIG. 3;

FIG. 5 is an exploded perspective view of the card case, showing various components of the card case;

FIG. 6 is a perspective view of a ball;

FIG. 7 is a table showing ball information;

FIG. 8 is a plan view showing a framed article;

FIG. 9 is a perspective view showing an encased article;

FIG. 10 is a block diagram showing a genuine/counterfeit determining apparatus; and

FIG. 11 is a flowchart showing a genuine/counterfeit determining method to be carried out by the genuine/counterfeit determining apparatus of FIG. 10.

### DESCRIPTION OF THE PREFERRED EMBODIMENTS

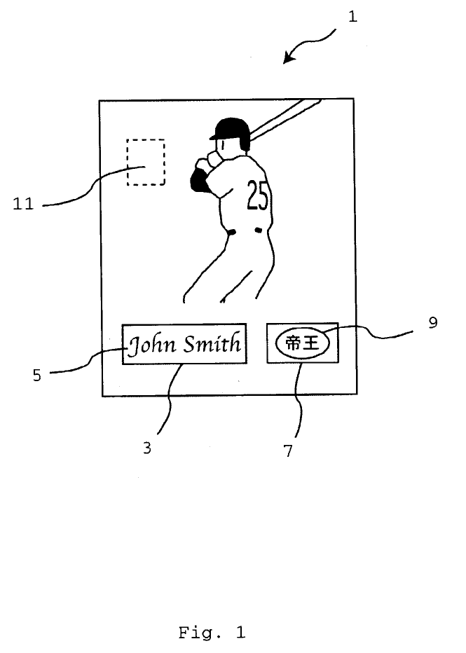

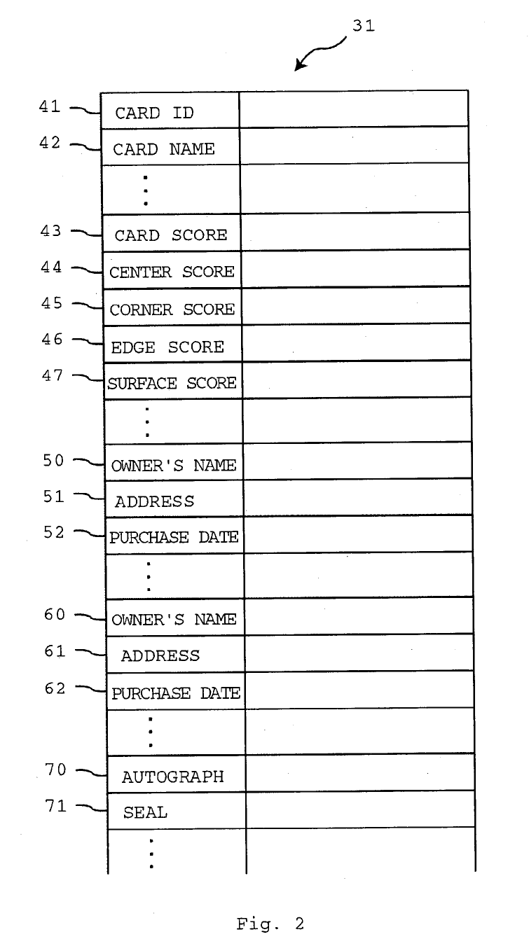

Collector's items according to various preferred embodiments of the present invention will now be described in detail with reference to the drawings. In a first embodiment of the present invention, the collector's item assumes the form of a trading card 1. FIG. 1 is a plan view of the trading card 1 according to the first embodiment of the present invention, and FIG. 2 is a table showing card information 31.

As shown in FIG. 1, the trading card 1 includes a substrate of, for example, paper or plastic, on which substrate a famous athlete's photograph is printed. In the example of FIG. 1, a signing portion 3 and a seal portion 7 are formed in a lower region of the trading card 1, and an IC chip 11 is mounted in an upper left region of the trading card 1.

An autograph 5 is signed in the signing portion 3, and a seal 9 is affixed in the seal portion 7. The signing portion 3 and the seal portion 7 may be surface-treated; e.g., by means of increasing the surface friction, so that clear signing and seal affixing can be performed, respectively. Alternatively, a holographic label or the like in which an autograph or a seal is recorded may be attached to the trading card 1. If signing and affixing of the seal are performed by the person whose photograph is printed on the trading card 1, the resultant trading card 1 would be more precious.

In FIG. 1, “John Smith” is signed as the autograph 5, and Chinese characters “TEI OH” meaning King (hereinafter called “King”) is affixed as the seal 9. “John Smith” of the autograph 5 is a signature signed by the person whose photograph appears on the trading card 1. “King” of the seal 9 is a nickname of the person “John Smith.” The seal 9 is exemplified by a name, a uniform number, a motto, a portrait, a zodiac sign, a horoscope, a coat of arms, an emblem, etc. of the person portrayed in the photograph; a character or a symbol relating to the person; and a seal profile, a stylized handwritten seal, etc. expressing a word or nickname symbolizing the person. The character, the symbol, the word, the nickname, etc. are preferably unique to the person. Alternatively, a document in the form of a warrant card guaranteeing the quality of the trading card 1 may be provided; the seal may be affixed on the trading card 1 and the document in a shared manner; or the engraved seal profile of the seal may be impressed three-dimensionally on the trading card 1 when affixing of the seal takes place.

In the IC chip 11, various kinds of card information 31 relating to the trading card 1 are stored. As shown in FIG. 2, the card information 31 includes a card ID 41, a card name 42, a card score 43, a center score 44, a corner score 45, an edge score 46, a surface sore 47, an owner's name 50, an address 51, a purchase date 52, another owner's name 60, another address 61, another purchase date 62, etc. Further, autograph row data 70 and seal data 71 are stored in the IC chip 11.

The card ID 41, the card name 42, etc. are items representing a card type. The card ID 41 is an identification number of the trading card 1. The card name 42 is the name of, for example, an athlete whose photograph is printed on the trading card 1.

The card score 43, the center score 44, the corner score 45, the edge score 46, the surface score 47, etc. are items regarding the appraisal result of the trading card 1; e.g., the appraisal result on whether the trading card 1 is genuine or counterfeit, or the appraisal result on the worth of the trading card 1. The center score 44 represents an evaluation point regarding a center portion of the trading card 1; the corner score 45 represents an evaluation point regarding corners of the trading card 1; the edge score 46 represents an evaluation point regarding edges of the trading card 1; the surface score 47 represents an evaluation point regarding surfaces of the trading card 1; and the card score 43 represents an overall evaluation point of the trading card 1.

The owner's name 50, the address 51, the purchase date 52, etc. and the owner's name 60, the address 61, the purchase date 62, etc. are information items regarding the past and present owners of the trading card 1. For example, the information regarding a client A, who is the present owner, is stored in the rows corresponding to the owner's name 50, the address 51, the purchase date 52, etc.; and the information regarding a person who owned the trading card 1 previous to the client A is stored in the rows corresponding to the owner's name 60, the address 61, the purchase date 62, etc.

Information as to whether or not the autograph 5 is signed on the trading card 1 is described in the row corresponding to the autograph data 70; and information as to whether or not the seal 9 is affixed on the carding card 1 is described in the row corresponding to the seal data 71. Further, if the autograph 5 or the seal 9 is signed or affixed, the date/time and site of execution of the signing or affixing the seal, image data of the autograph 5 or the seal 9, or the pronunciation, meaning, etc. of a character impressed as the seal 9 may be described.

As described above, the card information 31 is stored in the IC chip 11. That is, through reading the IC chip 11, the card type, the appraisal result of the trading card 1, the history of ownership, and the presence/absence of the autograph 5 or the seal 9 can be obtained. Further, it is possible to store in the IC chip 11 the voice of, for example, an athlete whose photograph is printed on the trading card 1, and a motion picture of, for example, a scene in which the athlete is signing on the trading card 1. Further, in the IC chip 11, there may be stored an image of the genuine autograph 5 or the genuine seal 9 of a person, “John Smith,” whose photograph is printed on the trading card 1.

The above-described trading card 1 may be examined in order to evaluate the quality of the trading card 1. The signature may be witnessed by a third party, and this may be recorded. A unique certification number may be assigned to the trading card 1.

As described above, in the trading card 1 according to the first embodiment, the seal portion 7 is provided in which the seal 9 is affixed by, for example, an athlete whose photograph is printed on the trading card 1. Since Chinese characters have been well-received not only in Japan but also in other countries, provision of the seal portion 7 can make the trading card 1 precious and encourage card collectors to purchase, sell, or exchange the trading card 1. Further, because information regarding the trading card 1 which includes information relating to the autograph and the seal can be stored in the IC chip 11, the credibility of the trading card 1 can be enhanced so that card collectors can exchange, sell, or purchase the trading card 1 safely.

Notably, the seal 9 may be affixed directly on the trading card 1 without providing the seal portion 7; and the autograph 5 may be signed directly on the trading card 1 without providing the signing portion 3.

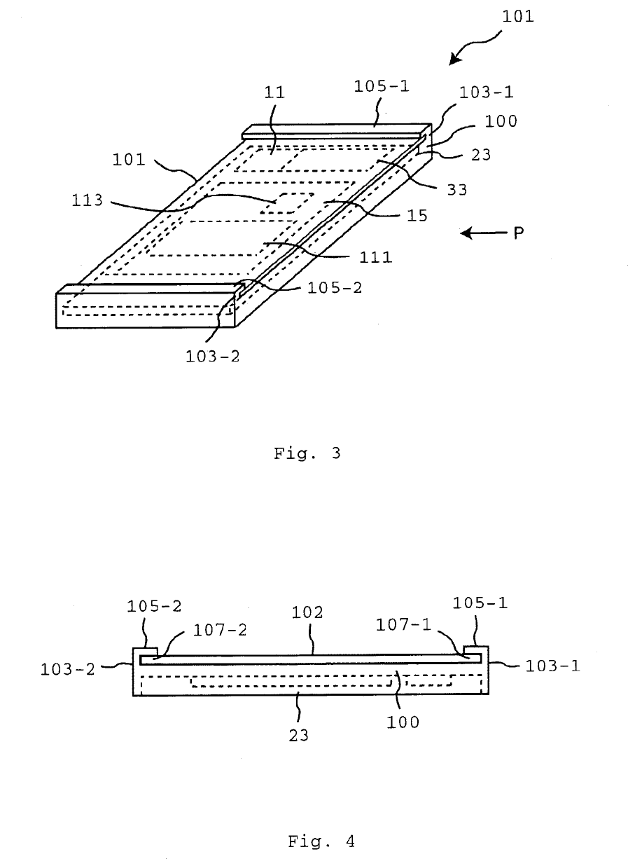

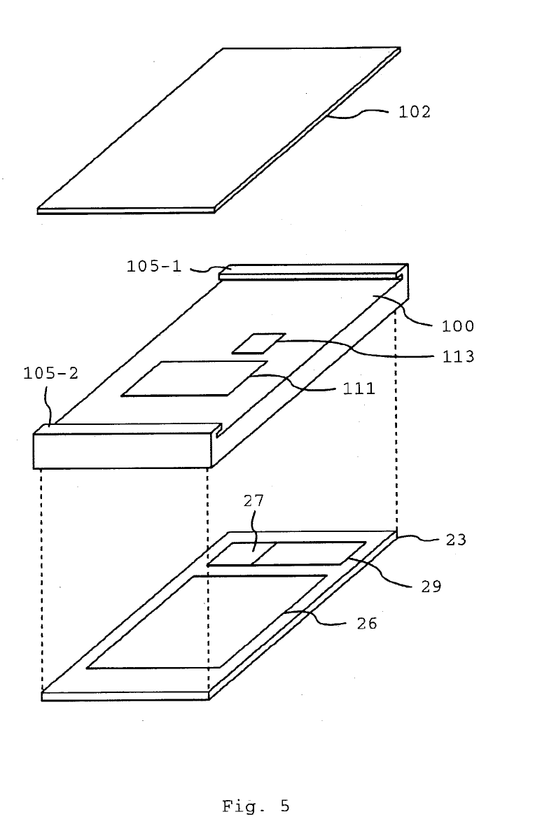

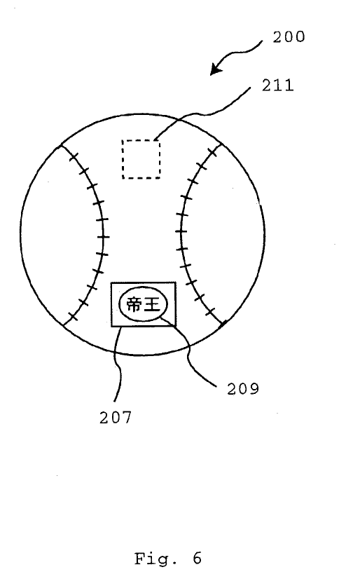

Next, a collector's item according to a second embodiment of the present invention will be described with reference to FIGS. 3 to 5. Here, a trading card 15 and a card case 101 for the trading card 15 will be described as an example of the collector's item. In the second embodiment, an IC chip 11 is not mounted in the trading card 15, and the trading card 15 is accommodated in the card case 101. FIG. 3 is a perspective view of the card case 101; FIG. 4 is a side view of the card case 101 as viewed from point P in FIG. 3; and FIG. 5 is an exploded perspective view of the card case 101, showing various components of the card case 101.

As shown in FIGS. 3 to 5, the card case 101 includes a case body 23, a lid 100, and a cover 102. The case body 23 assumes a plate-like shape, and formed on the case body 23 are a card accommodation portion 26, an IC chip accommodation portion 27, and a label accommodation portion 29, each assuming the form of a rectangular depression. The trading card 15 is accommodated in the card accommodation portion 26. An IC chip 11 is accommodated in the IC chip accommodation portion 27. A label 33 is accommodated in the label accommodation portion 29. Information necessary for checking the trading card 15, such as the card type and evaluation points representing the appraisal result, is described on the label 33. The label 33 may be omitted if the client A so desires.

The trading card 15 is accommodated in the card accommodation 26. The IC chip 11 is accommodated in the IC chip accommodation portion 27. The label 33 is accommodated in the label accommodation portion 29. Subsequently, the lid 100 is placed on the case body 23. By use of a special apparatus (not shown), the case body 23 and the lid 100 are completely welded together by means of ultrasonic waves so as to protect the trading card 15, the IC chip 11, etc.

The case body 23 and the lid 100 are formed of a transparent, hard material, such as acrylic plate, so that the card 15 and the label 33 can be viewed from the upper side and the lower side of the card case 101 through the case body 23 and the lid 100, respectively.

As shown in FIG. 5, a signing portion 111 and a seal portion 113 are provided on the top face of the lid 100. The signing portion 111 is a place where the athlete whose photograph is printed on the trading card 15 is to sign his or her autograph upon request. The signing portion 111 is surface-treated; e.g., by means of increasing the surface friction, in order to facilitate signing. Alternatively, a holographic label or the like in which the autograph is recorded may be attached to the signing portion 111. The seal portion 113 is a place where the athlete whose photograph is printed on the trading card 15 is to affix his or her seal upon request. The seal portion 113 is surface-treated; e.g., by means of increasing the surface friction, in order to facilitate affixing of the seal. Alternatively, a holographic label or the like in which the seal is recorded may be attached to the seal portion 113.

As shown in FIGS. 3 and 4, holder support portions 103-1 and 103-2 are provided at opposite ends of the lid 100. The holder support portions 103-1 and 103-2 support corresponding holding portions 105-1 and 105-2. The holding portions 105-1 and 105-2 project inward from the holder support portions 103-1 and 103-2.

As shown in FIG. 4, the holder support portions 103-1 and 103-2 and the holding portions 105-1 and 105-2 form grooves 107-1 and 107-2 in cooperation with the lid 100. When opposite ends of the cover 102 are fitted into the grooves 107-1 and 107-2, the cover 102 comes into close contact with the lid 100. The cover 102 protects the signing portion 111 and the seal portion 113 which are provided on the lid 100. The cover 102 may be formed of a thin film. In this manner, as shown in FIGS. 3 and 4, the case body 23, the lid 100, and the cover 102 are assembled closely.

Since the cover 102 is provided above the signing portion 111 and the seal portion 113, direct contact between a hand and the signing and seal portions 111 and 113 is avoided, and adhesion of dirt or the like to an autograph signed on the signing portion 111 and a seal affixed on the seal portion 113 can be prevented.

The card case 101 may be modified as follows. Holder support portions 103 and holding portions 105 are provided at predetermined positions of the lid 100; and the cover 102 is fitted into grooves formed thereby, in such a manner that the cover 102 comes into close contact with the top face of the lid 100. Further, instead of providing the holder support portions 103 and the holding portions 105, the cover 102 may be bonded or welded to the top face of the lid 100.

When the card case 101 is used, the trading card 15 and the IC chip 11 can be protected from damage; undesired actions such as removing the IC chip 11 and the label 33 and copying or overwriting the information can be prevented; and an autograph and a seal can be protected to thereby maintain the worth of the trading card 15 for a long period of time.

Notably, the seal may be affixed to the case without provision of the seal portion 113, and the autograph is signed directly on the case without provision of the signing portion 111.

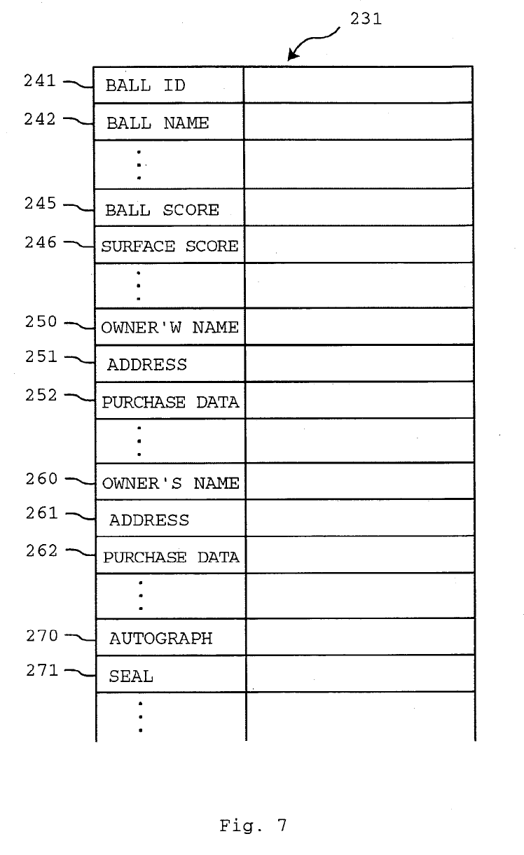

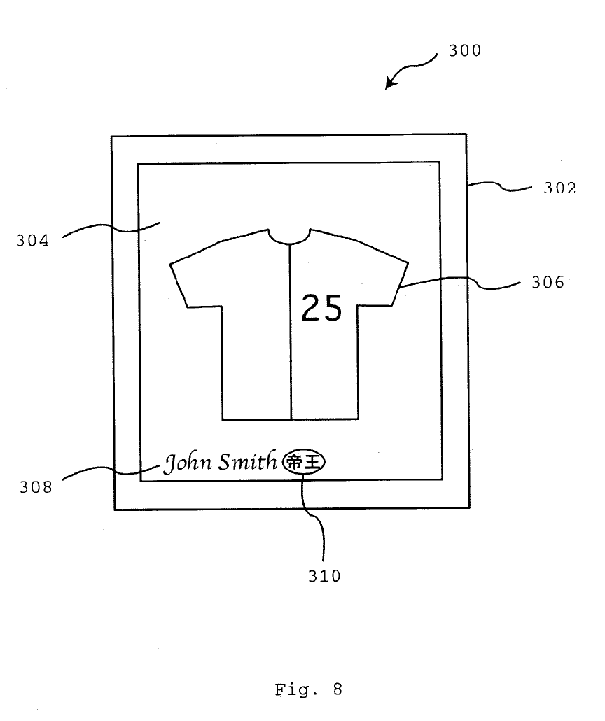

Next, a collector's item according to a third embodiment of the present invention will be described with reference to FIGS. 6 and 7. Here, a ball 200 will be described as an example of the collector's item. FIG. 6 is a perspective view of the ball 200; FIG. 7 is a table showing ball information 231. The ball 200 is exemplified by a baseball, a tennis ball, a basketball, and a volleyball.

As shown in FIG. 6, the ball 200 has a seal portion 207 and a built-in IC chip 211. A seal 209 is affixed in the seal portion 207. The seal portion 207 may be surface-treated; e.g., by means of increasing the surface friction, so that the seal can be affixed clearly. Alternatively, instead of providing the seal portion 207, a holographic label or the like in which a seal is recorded may be attached to the ball 200. If an athlete personally affixes a seal, the ball 200 becomes more precious.

In FIG. 6, Chinese characters “TEI OH” meaning King (hereinafter called “King”) are stamped as the seal 209. “King” of the seal 209 is a nickname of, for example, a famous major-league pitcher. The seal 209 is exemplified by a name, a uniform number, a motto, a portrait, a zodiac sign, a horoscope, a coat of arms, an emblem, etc. of the person in the photograph; a character or symbol relating to the person; and a seal profile, a stylized handwritten seal, etc. expressing a word or nickname symbolizing the person. The character, the symbol, the word, the nickname, etc. are preferably unique to the person. As another alternative, a document in the form of a warrant card guaranteeing the quality of the ball 200 may be provided; the seal may be affixed on the ball 200 and the document in a shared manner (this seal will be referred to as a “shared seal”); or the engraved seal profile of the seal may be impressed three-dimensionally on the ball 200, etc. when the seal is affixed (this seal will be referred to as an impressed seal).

Various kinds of ball information 231 regarding the ball 200 are stored in the IC chip 211. As shown in FIG. 7, the ball information 231 includes a ball ID 241, a ball name 242, a ball score 245, a surface score 246, an owner's name 250, an address 251, a purchase date 252, another owner's name 260, another address 261, another purchase date 262, etc. Further, autograph row data 270 and seal data 271 are stored in the IC chip 211.

The ball ID 241, the ball name 242, etc. are items representing a ball type. The ball ID 241 is an identification number of the ball 200. The ball name 242 is the name of, for example, an athlete.

The ball score 245, the surface score 246, etc. are items regarding the appraisal result of the ball 200; e.g., the appraisal result on whether the ball 200 is genuine or counterfeit, or the appraisal result on the worth of the ball 200. The surface score 246 represents an evaluation regarding a surface of the ball 200; e.g., an evaluation regarding whether or not the surface of the ball 200 has a scratch. The ball score 245 represents an overall evaluation of the ball 200.

The owner's name 250, the address 251, the purchase date 252, etc. and the owner's name 260, the address 261, the purchase date 262, etc. are information items regarding the past and present owners of the ball 200. For example, the information regarding a client A, who is the present owner, is stored in the rows corresponding to the owner's name 250, the address 251, the purchase date 252, etc.; and the information regarding a person who owned the ball 200 previous to the client A is stored in the rows corresponding to the owner's name 260, the address 261, the purchase date 262, etc.

Information regarding whether or not an autograph (not shown) is signed on the ball 200 is described in the row corresponding to the autograph data 270; and information regarding whether or not a seal 209 is affixed on the ball 200 is described in the row corresponding to the seal data 271. Further, if the autograph or the seal 209 is provided, the date/time and site of execution of signing or affixing the seal, image data of the autograph or the seal 209, the pronunciation and meaning of characters inscribed as the seal 209, and the type of the seal 209 may be described. The type of the seal 209 indicates whether the seal 209 is a shared seal or an impressed seal.

As described above, the ball information 231 is stored in the IC chip 211. That is, through reading the IC chip 211, the ball type, the appraisal result of the ball 200, the history of ownership, and the presence/absence of an autograph or a seal can be obtained. Further, it is possible to store in the IC chip 211 the voice of, for example, an athlete whose photograph is printed on the ball 200, and a motion picture of, for example, a scene in which the athlete is signing the ball 200. Further, in the IC chip 211, an image of the genuine autograph or the genuine seal of a person, “John Smith,” may be stored.

The above-described ball 200 may be examined in order to evaluate the quality of the ball 200. The signature may be witnessed by a third party, and this may be recorded. A unique certification number may be assigned to the ball 200. Further, a holographic label or the like in which a seal is recorded may be attached to the ball 200.

As described above, in the ball 200 according to the third embodiment, the seal portion 207 is provided in which the seal 209 is affixed by, for example, an athlete. Since Chinese characters have been well-received not only in Japan but also in other countries, provision of the seal portion 207 can make the ball 200 precious and encourage ball collectors -to purchase, sell, or exchange the ball 200. Further, because information regarding the ball 200; e.g., information relating to the autograph and the seal can be stored in the IC chip 211, the credibility of the ball 200 can be enhanced so that ball collectors can exchange, sell or purchase the ball 200 safely.

Notably, the seal 209 may be affixed directly on the ball 200 without providing the seal portion 207.

Next, a collector's item according to a fourth embodiment of the present invention will be described with reference to FIG. 8. Here, a framed article 300 will be described as an example of the collector's item. FIG. 8 is a perspective view of the framed article 300.

As shown in FIG. 8, the framed article 300 includes a frame 302, a signing paperboard 304, a uniform 306, an autograph 308, and a seal 310. The frame 302 serves to accommodate a painting (or drawing), a photograph (picture), etc. The frame 302 assumes the form of a small-thickness rectangular parallelepiped or the like which is formed of a frame body of wood or metal, and a transparent plate of glass or acrylic resin fitted in the frame body, so that the uniform 306, the autograph 308, the seal 310, etc. accommodated in the frame 302 can be viewed from the outside.

The signing paperboard 304 may serve as a mount for the article to be accommodated in the frame 302. The signing paperboard 304 may be formed of, for example, a thick, hard paperboard whose front surface is plain, colored, or provided with a pattern, etc. The signing paperboard 304 may have the autograph 308 and the seal 310 of, for example, a famous athlete. The portions of the signing paperboard 304 on which the autograph 308 and the seal 310 are to be provided may be surface-treated; e.g., by means of increasing the surface friction, so that clear signing and seal affixing can be performed. Alternatively, the autograph 308 and the seal 310 may be provided on the frame 302 or the uniform 306.

The framed article 300 may have a signing portion and a seal portion, which portions are places where the autograph 308 and the seal 310 are provided, respectively. A holographic label or the like in which an autograph or a seal is recorded may be attached to the framed article 300. If the athlete personally affixes the seal 310, the resulting framed article 300 would become more precious.

In FIG. 8, “John Smith” is inscribed as the autograph 308, and Chinese characters “TEI OH” meaning King (hereinafter called “King”) are stamped as the seal 310. “John Smith” of the autograph 308 is a signature signed by a person who had worn the uniform 306. “King” of the seal 310 is a nickname of the athlete “John Smith.” The seal 310 is exemplified by a name, a uniform number, a motto, a portrait, a zodiac sign, a horoscope, a coat of arms, an emblem, etc. of a person such as an athlete; a character or symbol relating to the person; and a seal profile, a stylized handwritten seal, etc. expressing a word or nickname symbolizing the person. The character, the symbol, the word, the nickname, etc. are preferably unique to the person. As another alternative, a document in the form of a warrant card guaranteeing the quality of the framed article 300 may be provided; the seal may be affixed on-the framed article 300 and the document in a shared manner; or the engraved seal profile of the seal may be impressed three-dimensionally on the signing paperboard 304, etc. when the seal is affixed.

In the framed article 300, the uniform 306 of, for example, a famous athlete is accommodated as the collector's item. In place of the uniform 306, a portion of the uniform, a famous athlete's photograph, etc. may be accommodated in the frame 302. Further, it may be the case that only the signing paperboard 304 is accommodated in the frame 302.

Further, an IC chip (not shown) may be mounted in one of the frame 302, the signing paperboard 304, and the uniform 306. In the IC chip, various kinds of information regarding the framed article 300 can be stored. The information to be stored in the IC chip includes an ID of the framed article 300, a name of the framed article 300, an owner's name, an address, a purchase date, information regarding the autograph and the seal, etc. Further, it is possible to store in the IC chip the voice of, for example, an athlete whose photograph is printed on the framed article 300, and a motion picture of, for example, a scene in which the athlete is signing on the framed article 300.

The above-described framed article 300 may be examined in order to evaluate the quality of the framed article 300. The above-described signing may be witnessed by a third party, and this may be recorded. A unique certification number may be assigned to the framed article 300.

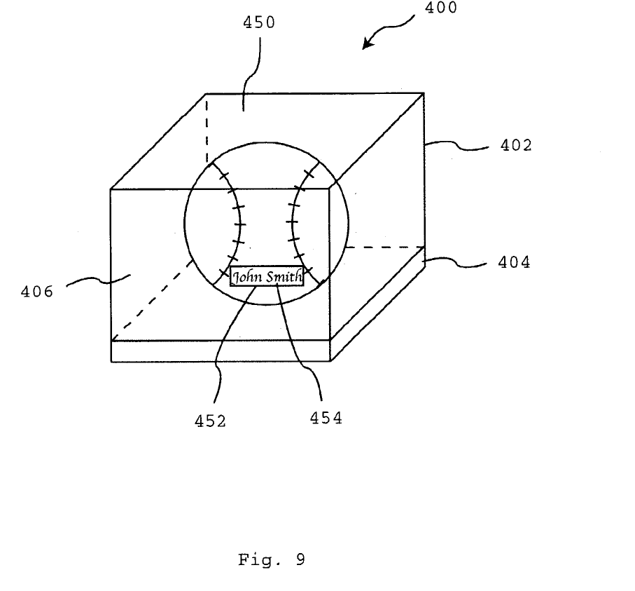

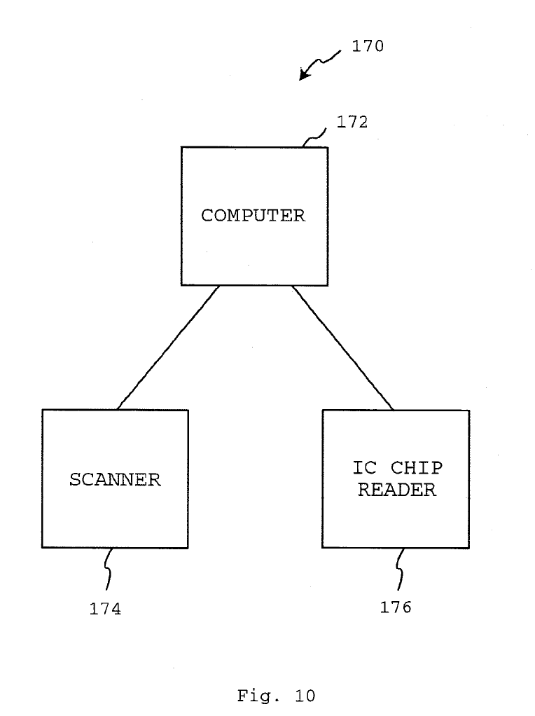

Next, a collector's item according to a fifth embodiment of the present invention will be described with reference to FIG. 9. Here, an encased article 400 will be described as an example of the collector's item. FIG. 9 is a perspective view of the encased article 400.

As shown in FIG. 9, the encased article 400 includes a case 402, a ball 450, etc. The case 402 has a display portion 406 and a base portion 404. The display portion 406 assumes the shape of a cube which is constituted by transparent plates of glass, acrylic resin, etc. so that the inside of the display portion 406 can be viewed from the outside. The base portion 404 is disposed under the display portion 406 and formed of, for example, metal or wood, and the collector's item is displayed on the top face of the base portion 404.

In the example of FIG. 9, the ball 450 is displayed as the collector's item. The base portion 404 may be provided with projections or the like in order to fixedly hold the ball 450 so that the ball 450 can be displayed in a stable manner. The collector's item is not limited to the ball 450, and may be a sporting article, such as a baseball glove or a tennis racket. In such an alternative case, the shape of the case 402 may be modified in accordance with the shape of the collector's item.

The ball 450 is provided with a label 452 and an autograph 454. The label 452 assumes, for example, the form of a holographic label in which the autograph 454 of, for example, a famous athlete is recorded. The ball 450 may be provided with a seal, etc. in addition to the autograph 454. The portions of the ball 450 on which the autograph 454, the seal, etc. are to be provided may be surface-treated; e.g., by means of increasing the surface friction, so that clear signing and seal affixing can be performed. Further, the label 452, the autograph 454, the seal, etc. may be provided on the case 402. Since the autograph 454 is provided on the label 452, a famous athlete's can personally provide an autograph, a seal, etc. on various kinds of collector's items without these collector's items being brought to the athlete. Notably, in FIG. 9, “John Smith” is written as the autograph 454. “John Smith” of the autograph 454 is a signature made by, for example, a famous major-league pitcher.

Further, the encased article 400 may have a signing portion and a seal portion, which portions are places where the autograph 454 and the seal are provided, respectively. If the seal is personally affixed by an athlete, the encased article 400 would become more precious. Notably, the seal is exemplified by a name, a uniform number, a motto, a portrait, a zodiac sign, a horoscope, a coat of arms, an emblem, etc. of a person such as an athlete; a character or symbol relating to the person; and a seal profile, a stylized handwritten seal, etc. expressing a word or nickname symbolizing the person. The character, the symbol, the word, the nickname, etc. are preferably unique to the person. As another alternative, a document in the form of a warrant card guaranteeing the quality of the encased article 400 may be provided; the seal may be stamped on the ball 450 and the document in a shared manner; or the engraved seal profile of the seal may be impressed three-dimensionally on the ball 450, etc. when the seal is affixed.

Further, an IC chip (not shown) may be mounted in the case 402 or the ball 450. In the IC chip, various kinds of information regarding the encased article 400 can be stored. The information to be stored in the IC chip includes an ID of the encased article 400, a name of the encased article 400, an owner's name, an address, a purchase date, information regarding the autograph and the seal, etc. Further, it is possible to store in the IC chip the voice of, for example, an athlete, and a motion picture of, for example, a scene in which the athlete is signing the encased article 400. An image of a genuine seal or autograph of a person, “John Smith,” may be stored.

The above-described encased article 400 may be examined in order to evaluate the quality of the encased article 400. The signature may be witnessed by a third party, and this may be recorded. A unique certification number may be assigned to the encased article 400.

As described above, according to the first to fifth embodiments, by the provision of the seal, the IC chip, etc., it is possible to increase values of collector's items and framed collector's items such as trading cards, card cases and balls, and make them durable for long-term storage, thereby promoting sales, exchange, and purchase of the collector's items.

Next, as a sixth embodiment of the present invention there will be described a genuine/counterfeit determining apparatus for determining whether an autograph or seal provided on each of collector's items and framed collector's items, such as trading cards, card cases, and balls, according to the first to fifth embodiments is genuine or counterfeit.

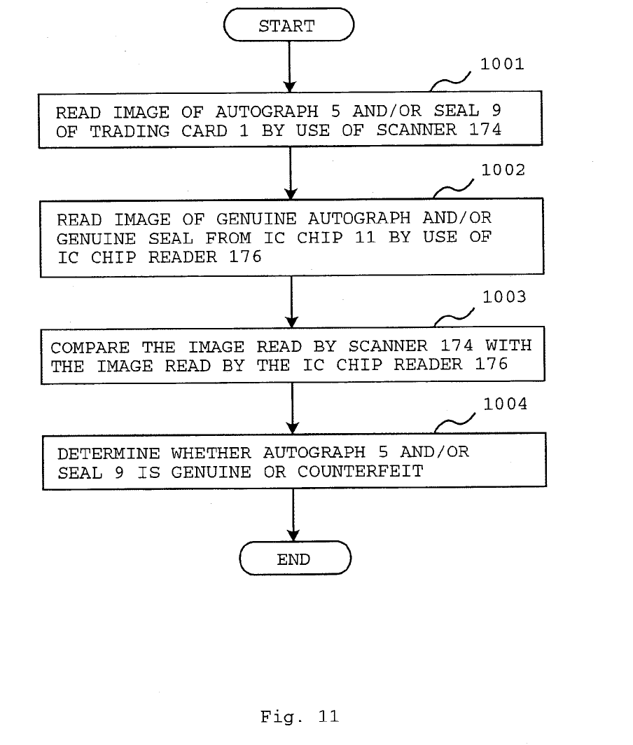

FIG. 10 is a block diagram showing the genuine/counterfeit determining apparatus 170 according to the sixth embodiment, and FIG. 11 is a flowchart showing a genuine/counterfeit determining method to be carried out by the genuine/counterfeit determining apparatus 170. In the sixth embodiment, an image of each of the genuine autograph and the genuine seal is stored in the IC chip 11 or the IC chip 211 of the first through fifth embodiments. The storing of this image can be carried out by, for example, scanning the images of the genuine autograph and the genuine seal by use of a scanner as an image reading unit, and storing the thus-obtained image data in the IC chip 11 or the IC chip 211.

As shown in FIG. 10, the genuine/counterfeit determining apparatus 170 includes a computer 172, a scanner 174, an IC chip reader 176, etc. The computer 172 assumes the form of a personal computer or the like which includes an input unit, a display unit, a storage unit, etc., all of which are not shown. The computer 172 controls the following operations of the genuine/counterfeit determining apparatus 170. Namely, the computer 172 serves to receive the input of instructions to the scanner 174 and the IC chip reader 176, display the state of operation of the scanner 174 and the IC chip reader 176, and control the drive of the scanner 174 and the IC chip reader 176; serves to save and display the image data read from the scanner 174 and the IC chip reader 176; and serves to compare the image read by the by the scanner 174 with the image read by the IC chip reader 176 to thereby determine whether the autograph or seal is genuine or counterfeit.

The scanner 174, which serves as an image reading unit, reads an image of, for example, the autograph 5, the autograph 308, the seal 9, the seal 209, or the seal 310, each of which is provided on a collector's item such as the trading card 1, the ball 200, or the framed article 300, and transfers the image data to the computer 172. The IC chip reader 176 reads data stored in the IC chip 11 or 211, which is provided on a collector item such as the trading card 1, the card case 101, or the ball 200. Here, the images of the genuine autograph and the genuine seal in particular are read.

Next, the steps of operation of the genuine/counterfeit determining apparatus 170 for determining whether the autograph or seal is genuine and counterfeit will be described with reference to FIG. 11. Here, there will be described, as an illustrative example, the procedure in which determination is made as to whether the autograph 5 and the seal 9 provided on the trading card 1 according to the first embodiment are genuine or counterfeit. In this case, we assume that the image of the genuine autograph and the image of the genuine seal are already stored in the IC chip 11.

First, the image of each of the autograph 5 and the seal 9 which are provided on the trading card 1 are read by the scanner 174 as the computer 172 has so instructed (step 1001). The image of the genuine autograph and the image of the genuine seal, which images are stored in the IC chip 11, are read by the IC chip reader 176 as instructed by the computer 172 (step 1002).

The image of the autograph 5 read by the scanner 174 and the image of the seal 9 read by the scanner 174 are compared with the image of the genuine autograph read by the IC chip reader 176 and the image of the genuine seal read by the IC chip reader 176, respectively, on the computer 172 (step 1003). This comparison can take place by use of commercially available software that compares two images in order to determine whether or not these two images are identical.

If the comparison shows that the two images are identical, the autograph 5 or the seal 9 is genuine; and if the comparison shows that the two images compared are different, the autograph 5 or the seal 9 is counterfeit. Thereby, a determination is made as to whether each of the autograph 5 and the seal 9 is genuine or counterfeit (step 1004).

As described above, according to the genuine/counterfeit determining apparatus 170 of the present embodiment, the image of a genuine autograph or a genuine seal can be stored in the IC chip 11, the IC chip 211, etc., and the image of the autograph 5 or the seal 9 which are provided on the trading card 1 can be compared with the stored image of the genuine autograph or the genuine seal to thereby determine whether the image of the autograph 5 or the seal 9 on the trading card 1 is genuine or counterfeit.

In the foregoing description, the various preferred embodiments of the trading card, the card case, the collector's item, and the genuine/counterfeit determining apparatus according to the present invention are explained with reference to the accompanying drawings. However, the present invention should by no means be limited to these embodiments. As is obvious to one skilled in the art, various modification is possible within the scope of the technical concept defined in the appended claims, and, as a matter of course, such modifications fall within the technical scope of the present invention.

For example, instead of providing the IC chip accommodation portion 27 in the card case 101 of the second embodiment, the trading card in which the IC chip 11 is mounted may be accommodated in the card case 101. Further, the collector's item of the third embodiment may be a baseball bat, a baseball glove, a tennis racket, etc.

Notably, determination of whether the autograph or the seal provided on a collector's item other than the trading card 1; e.g., the ball 200, the framed article 300, or the encased article 400 is genuine or counterfeit can take place by the same procedure as in the case of the trading card 1. The determination between genuine and counterfeit is possible when the seal or the autograph is provided in a seal portion or a signing portion, or when the seal or the autograph is provided on a label.

As described above, according to the present invention, because a seal of, for example, an athlete whose photograph appears on a collector's item such as a trading card is affixed on the collector's item, the resulting collector's item is sufficiently precious to promote sales, exchange, and purchase of the collector's item. Further, because information regarding a collector's item, which information includes information relating to an autograph and a seal, can be stored in the IC chip, the credibility of the collector's item can be increased.

What is claimed is:

1. A trading card having a seal.

2. A trading card according to claim 1, wherein a front surface of the trading card on which surface the seal is to be affixed is surface-treated so as to facilitate sealing.

3. A trading card according to claim 1, further having an autograph.

4. A trading card according to claim 1, wherein the seal is affixed on a label.

5. A trading card according to claim 3, wherein one of the seal and the autograph is provided on a label.

6. A trading card according to any one of claims 1 to 5, wherein an IC chip is mounted in the trading card.

7. A trading card according to claim 6, wherein at least information relating to the seal is stored in the IC chip.

8. A trading card according to claim 6, wherein at least information relating to the autograph is stored in the IC chip.

9. A trading card according to claim 6, wherein an image of at least one of a genuine seal and a genuine autograph is stored in the IC chip so that whether one of the seal and the autograph on the trading card is genuine or counterfeit can be determined.

10. A card case comprising:
a card accommodation portion for accommodating a trading card;
an IC chip accommodation portion for accommodating an IC chip; and
a seal.

11. A card case according to claim 10, wherein a front surface of the card case on which surface the seal is to be affixed is surface-treated so as to facilitate sealing.

12. A card case according to claim 10 or 11, wherein at least information relating to the seal is stored in the IC chip.

13. A card case according to claim 10, further comprising an autograph.

14. A card case according to claim 10 or 13, wherein one of the seal and the autograph is provided on a label.

15. A card case according to claim 13, wherein at least information relating to the autograph is stored in the IC chip.

16. A card case according to claim 10, wherein an image of at least one of a genuine seal and a genuine autograph is stored in the IC chip so that whether one of the seal and the autograph on the card case is genuine or counterfeit can be determined.

17. A collector's item having a seal.

18. A collector's item according to claim 17, wherein a front surface of the collector's item on which the seal is to be affixed is surface-treated so as to facilitate sealing.

19. A collector's item according to claim 17, further having an autograph.

20. A collector's item according to claim 17, wherein the seal is affixed on a label.

21. A collector's item according to claim 19, wherein one of the seal and the autograph is provided on a label.

22. A collector's item according to any one of claims 17 to 21, wherein an IC chip is mounted in the collector's item.

23. A collector's item according to claim 22, wherein at least information relating to the seal is stored in the IC chip.

24. A collector's item according to claim 22, wherein at least information relating to the autograph is stored in the IC chip.

25. A collector's item according to any of claims 17 to 21, wherein the collector's item is a ball.

26. A collector's item according to claim 22, wherein the collector's item is a ball.

27. A collector's item according to any of claims 17 to 21, wherein the collector's item is a sports-related article.

28. A collector's item according to claim 22, wherein the collector's item is a sports-related article.

29. A collector's item according to claim 22, wherein an image of at least one of a genuine seal and a genuine autograph is stored in the IC chip so that whether one of the seal and the autograph on the collector's item is genuine or counterfeit can be determined.

30. A collector's item according to claim 26, wherein an image of at least one of a genuine seal and a genuine autograph is stored in the IC chip so that whether one of the seal and the autograph on the collector's item is genuine or counterfeit can be determined.

31. A framed collector's item wherein
a collector's item is accommodated in a frame; and
one of the collector's item and the frame has a seal.

32. A framed collector's item wherein
a collector's item is placed on a mat;
both the collector's item and the mat are accommodated in a frame; and
at least one of the collector's item, the mat, and the frame has a seal.

33. A framed collector's item according to claim 31 or 32, wherein a front surface of a portion of the framed collector's item in which portion the seal is to be affixed is surface-treated so as to facilitate sealing.

34. A framed collector's item according to claim 31 or 32, having an autograph.

35. A framed collector's item according to claim 31 or 32, wherein the seal is affixed on a label.

36. A framed collector's item according to claim 34, wherein one of the seal and the autograph is provided on a label.

37. A framed collector's item according to claim 31 or 32, wherein an IC chip is mounted in at least one of the collector's item, the mat, and the frame.

38. A framed collector's item according to claim 37, wherein at least information relating to one of a seal and an autograph is stored in the IC chip.

39. A framed collector's item according to claim 31 or 32, wherein the collector's item is a sports-related article.

40. A frame collector's item according to claim 37, wherein the collector's item is a sports-related article.

41. A framed collector's item according to claim 37, wherein an image of at least one of a genuine seal and a genuine autograph is stored in the IC chip so that whether one of the seal and the autograph on the collector's item is genuine or counterfeit can be determined.

42. A framed collector's item according to claim 40, wherein an image of at least one of a genuine seal and a genuine autograph is stored in the IC chip so that whether one of the seal and the autograph on the collector's item is genuine or counterfeit can be determined.

43. A genuine/counterfeit determining apparatus comprising:
means for reading an image of one of a genuine seal and a genuine autograph which are stored in an IC chip;
means for reading an image of one of a seal and an autograph which are provided on a collector's item;
means for comparing the image of one of the genuine seal and the genuine autograph with the image of the corresponding one of the seal and the autograph which are provided on the collector's item; and
means for determining, from the result of the comparison, whether one of the seal and the autograph which are provided on the collector's item is genuine or counterfeit.

44. A genuine/counterfeit determining apparatus according to claim 43, wherein the collector's item is a trading card according to claim 9.
